(19) United States
(12) Patent Application Publication
(10) Pub. No.: US 2016/0222879 A1
(43) Pub. Date: Aug. 4, 2016

(54) ENGINE-PUMP SUPPORT UNIT

(71) Applicant: CATERPILLAR INC., Peoria, IL (US)

(72) Inventors: Marc DI SCHINO, Varces Allieres et Risset (FR); Eric ROLLAND, Grenoble (FR); Paul A. DVORAK, SR., Hanna City, IL (US); Florent THUBERT, Eybens (FR)

(73) Assignee: Caterpillar Inc., Peoria, IL (US)

(21) Appl. No.: 14/917,717

(22) PCT Filed: Aug. 13, 2014
(86) PCT No.: PCT/US2014/050898

§ 371 Date: Mar. 9, 2016

(30) Foreign Application Priority Data
Sep. 11, 2013 (GB) 1316184.9

(51) Int. Cl. F02B 63/06; F02F 7/00

(52) U.S. Cl. CPC F02B 63/06; F02F 7/0046

(57) ABSTRACT

An adaptor for mounting a pump to an engine is disclosed. The adaptor may have a main body. The main body may have a pump side for mounting the pump to the adaptor. The main body may also have an engine side for mounting the adaptor to the engine. In addition, the main body may have an outer periphery. The adaptor may also have a wall projecting from the pump side. The wall may extend around at least a part of the outer periphery of the main body.

### TECHNICAL FIELD

The present disclosure relates to an engine-pump support unit and more specifically to the engine-pump support unit disposed between an engine flywheel casing and a pump.

### BACKGROUND

Many machines may utilize pumps which are driven by an engine provided on the machine. Some of the machines may require the pumps to be supported on the engine and thus require a mounting device. A mounting device may be disposed between the pump and an engine flywheel casing in order to attach the pump to the engine. Known designs of this mounting arrangement include a three piece structure having a plate, a beam and a yoke. More specifically, the plate is attached to the engine flywheel casing, the beam extends below the pump and the yoke is upstanding from one end of the beam in order to provide support to the pump. The known solutions may occupy a lot of space, may be cumbersome and may be expensive. Moreover, in some situations, reduced space may be available for the mounting arrangement, based on the application.

Hence, there is a need for an improved design of the mounting arrangement.

### SUMMARY OF THE DISCLOSURE

In one aspect of the present disclosure, an adaptor for mounting a pump to an engine is provided. The adaptor includes a main body having a pump side, an engine side and an outer periphery. The pump side is for mounting the pump to the adaptor. The engine side is for mounting the adaptor to the engine. A wall projects from the pump side and extends around at least a part of the outer periphery of the main body.

Other features and aspects of this disclosure will be apparent from the following description and the accompanying drawings.

### BRIEF DESCRIPTION OF THE DRAWINGS

FIG. 1 is a perspective view of an exemplary pump and engine assembly;

FIGS. 2 and 3 are perspective views of a pump side of an adaptor, according to the disclosure; and

FIG. 4 is a perspective view of an engine side of the adaptor shown in FIGS. 2 and 3.

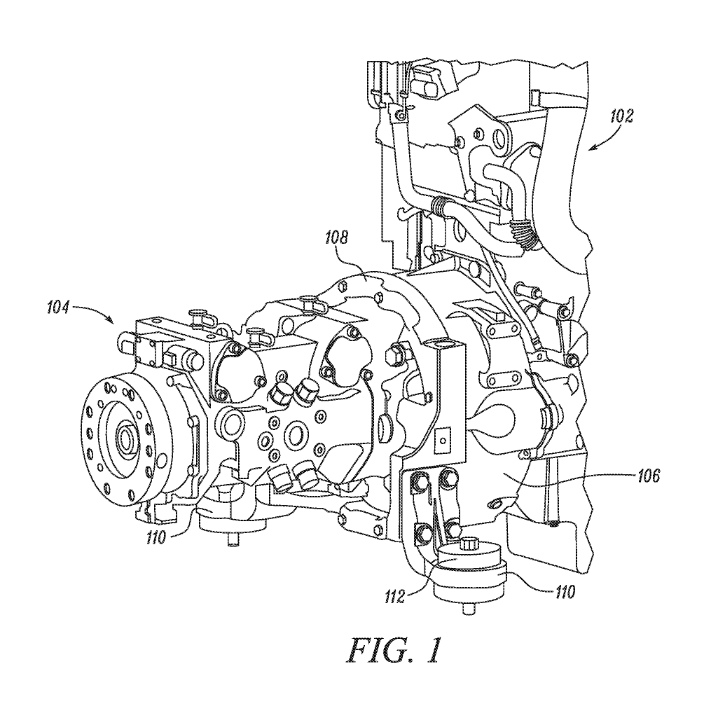

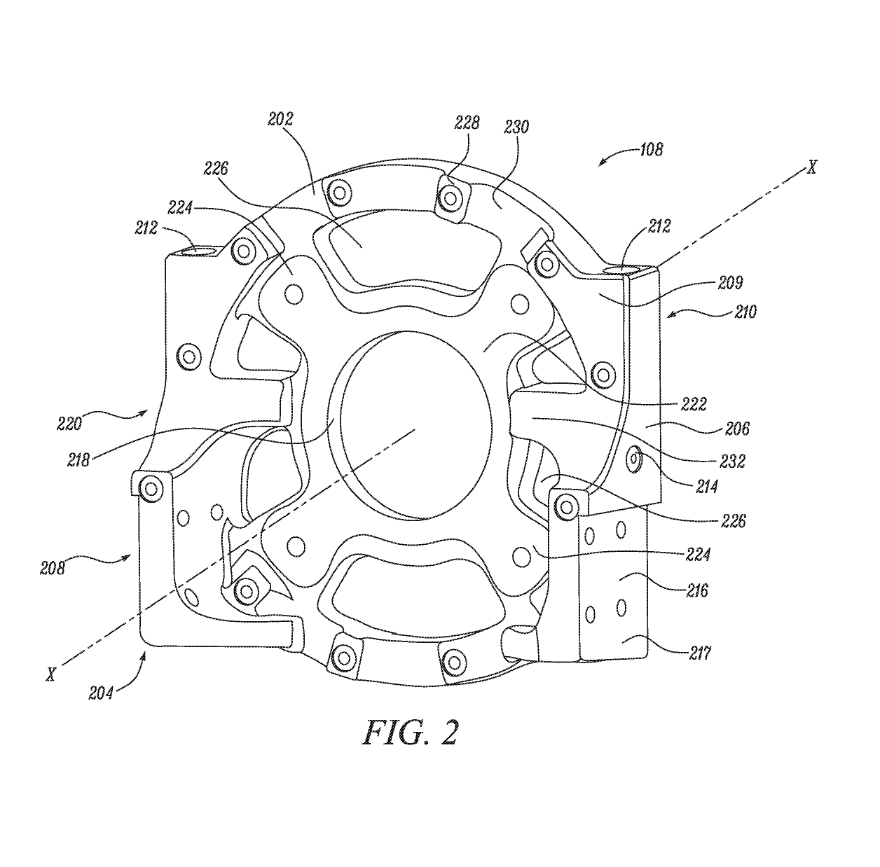

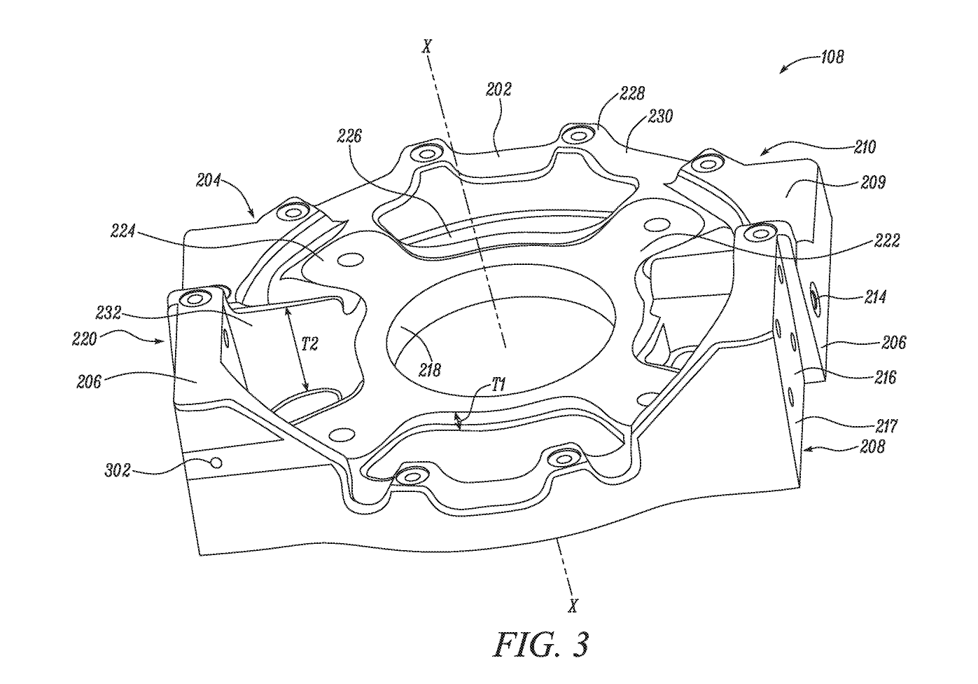

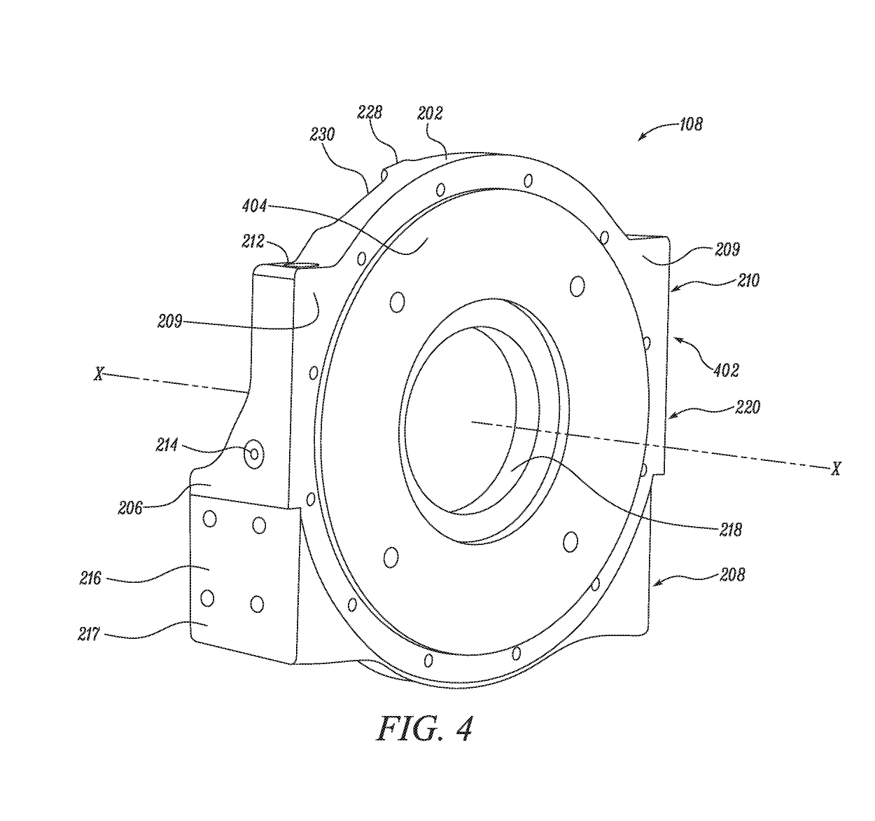

### DETAILED DESCRIPTION

Wherever possible, the same reference numbers will be used throughout the drawings to refer to the same or the like parts. FIG. 1 illustrates an exemplary arrangement including an engine 102 and a pump 104. The present disclosure relates to an adaptor 108 for mounting the pump 104 to an engine flywheel casing 106 of the engine 102. Various views of the adaptor 108 are shown in FIGS. 2, 3 and 4. The adaptor 108 includes a main body 202 having a pump side 204 (shown in FIGS. 2 and 3) and an engine side 402 (shown in FIG. 4). The main body 202 of the adaptor 108 may have a plate like structure possibly with a substantially circular shape. The adaptor 108 may be made of any suitable metal known in the art.

Referring to FIGS. 2 and 3, the adaptor 108 also includes a wall 206 extending from at least a part of an outer periphery of the main body 202. The wall 206 extends in a direction parallel to that of an axis X-X of the adaptor 108. The wall 206 is present on the pump side 204 of the adaptor 108, and more specifically projects in the direction away from the engine flywheel casing 106. In one embodiment, the wall 206 may be positioned in a lower section 208 of the main body 202. The wall 206 is configured to provide mechanical support to the adaptor 108. In one embodiment, a portion of the wall 209 may extend in a co-planar manner from the outer periphery of the adaptor 108. This portion of the wall 209 may be positioned in an upper section 210 of the main body 202. This portion of the wall 209 may provide further mechanical strength and support to the overall structure of the adaptor 108. This portion of the wall 209 may also include lifting points 212 for assembly and removal of the adaptor 108. As shown in FIG. 3, a hole 302 may be provided on a bottom surface of the adaptor 108 in order to hold a coolant line via a clip.

A foot mounting portion 216 may be defined on an outer face 217 of the wall 206. A foot 110 (see FIG. 1) may be attached to the foot mounting portion 216 using known mechanical fasteners like bolts, rivets, screws and so on. In the accompanying figures, a pair of the foot mounting portions 216 is defined on either side of a lower section 208 of the adaptor 108. The foot mounting portions 216 may be generally planar and lie in a plane normal to a plane of the main body 202 of the adaptor 108. Also, the foot mounting portions 216 may have a pad like configuration and may extend axially in the direction away from the engine flywheel casing 106, in order to prevent interference with the engine flywheel casing 106. An absorbing element 112 (see FIG. 1) may be attached to a base of the foot 110. The foot 110 may allow for the adaptor 108 to be attached to a frame (not shown) or support member (not shown) of a machine for support. The absorbing elements 112 of the foot 110 may prevent transfer of vibrations to and fro between the engine 102 and the frame.

Referring to FIGS. 2 to 4, the main body 202 has a through hole 218 provided in an inner portion 220 of the adaptor 108. The hole 218 allows for passage of a shaft of the pump 104 through the adaptor 108 and into the flywheel within the engine flywheel casing 106.

Further, as shown in FIGS. 2 and 3, a raised portion 222 exists surrounding the hole 218 on the pump side 204 of the adaptor 108. The raised portion 222 may have a thickness T1 (see FIG. 3). In one embodiment, webs 224 may extend radially outwards from the hole 218 towards the outer periphery of the main body 202. In the illustrated embodiment four webs 224 are shown, such that each of the pairs of webs 224 is located at substantially opposed positions to one another. The pump 104 may be mounted to these webs 224 present on the pump side 204 of the adaptor 108.

Additionally, the raised portion 222 and the outer periphery of the main body 202 may define pockets 226 or depressions 226 on various parts of a surface of the pump side 204 of the adaptor 108. These pockets 226 may be positioned in locations experiencing relatively lesser mechanical stress. Voids created by the pockets 226 may result in an overall lesser volume of the material needed to form the adaptor 108. This may allow for a reduction in cost associated with the material utilized in forming the adaptor 108.

The outer periphery of the main body 202 also includes raised protrusions 228 configured to receive mechanical fasteners such as bolts and screws for attaching the adaptor 108 to the engine flywheel casing 106. In one embodiment, a pattern of alternate raised protrusions 228 and depressions 230 are formed on the outer periphery of the main body 202, allowing for reduction in the volume of the material used to form the adaptor 108, and thereby providing a cost effective solution.

As illustrated in FIGS. 2 and 3, a rib 232 may be provided extending from the wall 206 towards a centre of the adaptor 108. In one embodiment, a pair of the ribs 232 is provided in the inner portion 220 of the main body 202 of the adaptor 108. As is clearly visible in FIG. 3, these ribs 232 have a thickness ‘T2’ greater than the thickness ‘T1’ of the raised portion 222. These ribs 232 may provide improved mechanical support and stiffness to the main body 202, in order to hold the pump 104 securely in place with respect to the pump side 204 of the main body 202 of the adaptor 108.

FIG. 4 illustrates the engine side 402 of the main body 202 of the adaptor 108. The engine side 402 is configured to attach the adaptor 108 to the engine flywheel casing 106. As seen, the engine side 402 includes a substantially raised mounting face 404 having a step like configuration to align the adaptor 108 with engine flywheel casing 106. The diameter of the raised mounting face 404 of the main body 202 of the adaptor 108 may coincide or be equal to that of the engine flywheel casing 106 in order to provide a good fit.

The adaptor 108 disclosed herein provides improved mechanical support due to the stiff structure of the design. Further, the design of the adaptor 108 allows for installation and also is less costly due to savings in the material used to form the adaptor 108.

### INDUSTRIAL APPLICABILITY

The installation of the adaptor 108 will now be described in detail. The adaptor 108 is configured to be lifted and positioned in place with the help of lift arms attached to the lifting points 212 on the adaptor 108. The adaptor 108 may then be bolted to the surface of the engine flywheel casing 106. Further, the pump 104 is configured to be bolted to the pump side 204 of the adaptor 108. The mounting foot 110 or leg or associated known absorbing elements 112 may be attached to the foot mounting portion 216 defined on the outer face 217 of the wall 206 of the adaptor 108. The base of the foot 110 may then be affixed to the frame of the machine.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

1. An adaptor for mounting a pump to an engine, the adaptor comprising:
a main body comprising:
a pump side for mounting the pump to the adaptor;
an engine side for mounting the adaptor to the engine; and
an outer periphery; and
a wall projecting from the pump side and extending around at least a part of the outer periphery of the main body.

2. The adaptor of claim 1, wherein the wall is positioned in a lower section of the main body of the adaptor.

3. The adaptor of claim 1, further comprising a rib provided on the pump side and extending inwards from the outer periphery of the main body towards a center of the adaptor.

4. The adaptor of claim 3, wherein the rib is one of a pair of ribs disposed at generally opposed locations on the pump side of the main body of the adaptor.

5. The adaptor of claim 1, wherein a through hole is provided in the adaptor, the through hole being configured to receive a shaft for interconnecting the pump and the engine.

6. The adaptor of claim 5, wherein the through hole is provided in an inner portion of the main body and a plurality of webs extend outwards from the inner portion towards the outer periphery of the main body, the plurality of webs being configured for attachment to the pump.

7. The adaptor of claim 1, wherein pockets are defined in the pump side of the main body and at locations of reduced mechanical stress.

8. The adaptor of claim 1, further comprising at least one foot mounting portion configured to receive a mounting foot.

9. The adaptor of claim 8, wherein the foot mounting portion is defined on an outer face of the wall.

10. The adaptor of claim 9, wherein the foot mounting portion is generally planar and lies in a plane normal to a plane of the main body.

11. The adaptor of claim 1, wherein the engine side of the main body has a generally raised mounting face configured for interconnecting the adaptor and the engine.

12. The adaptor of claim 11, wherein the raised mounting face has a substantially circular configuration having a diameter substantially equal to that of the engine to which the adaptor is configured to connect.

13. An engine arrangement, comprising:
an engine;
a pump disposed adjacent the engine; and
an adaptor configured to mount the pump to the engine, the adaptor comprising:
a main body, including:
a pump side for mounting the pump to the adaptor;
an engine side for mounting the adaptor to the engine; and
an outer periphery; and
a wall projecting from the pump side and extending around at least a part of the outer periphery of the main body.

14. The engine arrangement of claim 13, further including a pair of ribs disposed at generally opposed locations on the pump side of the main body of the adaptor.

15. The engine arrangement of claim 13, wherein the adapter includes a through hole configured to receive a shaft for interconnecting the pump and the engine, and the adaptor further includes a plurality of webs extending outwards from the through hole towards the outer periphery of the main body, the webs being configured for attachment to the pump.

16. The engine arrangement of claim 15, further including pockets defined in the pump side of the main body, the pockets being disposed between the webs.

17. The engine arrangement of claim 13, wherein the adaptor includes a generally planar foot mounting portion disposed in a plane normal to a plane of the main body.

18. The engine arrangement of claim 17, further including at least one foot configured to attach the foot mounting portion to a frame.

19. The engine arrangement of claim 18, further including an absorbing element attached to a base of the at least one foot.

20. The engine arrangement of claim 13, wherein the engine side of the main body of the adaptor has a generally raised mounting face configured for interconnecting the adaptor with the engine.
